(19) United States
(12) Patent Application Publication
(10) Pub. No.: US 2012/0109935 A1
(43) Pub. Date: May 3, 2012

(54) OBJECT MODEL TO KEY-VALUE DATA MODEL MAPPING

(75) Inventor: Henricus Johannes Maria Meijer, Mercer Island, WA (US)

(73) Assignee: MICROSOFT CORPORATION, Redmond, WA (US)

(21) Appl. No.: 12/938,168

(22) Filed: Nov. 2, 2010

(51) Int. Cl. G06F 17/30

(52) U.S. Cl. 707/713; 707/756; 707/E17.044; 707/E17.017

(57) ABSTRACT

Access to data is facilitated by mapping between an object model and a key-value data model that supports a notion of worlds. The object model can be expressed in a programming language that supports language-integrated queries. One or more query operators comprising a language-integrated query can be specified and executed with respect to a key-value world.

### BACKGROUND

A data model describes how data can be stored and accessed. More formally, data models define data entities and relationships between the data entities. The primary objective of a data model is to provide a definition and format of data to facilitate management and processing of vast quantities of data. One application of data models is database models, which define how a database or other store is structured and utilized. A database model can be relational or non-relational.

In a relational model, or more particularly a relational database, data is structured in terms of one or more tables. Tables are relations that comprise a number of columns and rows, wherein the named columns are referred to as attributes and rows capture data for specific entity instances. For example, a table can capture information about a particular entity such as a book in rows, also called tuples, and columns. The columns identify various attributes of an entity such as the title, author, and year of publication of a book. The rows capture an instance of an entity such as a particular book. In other words, each row in the table represents attributes of a particular book. Further yet, a table can include primary and foreign keys that enable two or more tables to be linked together.

Amongst many implementations of a non-relational model, a key-value model is one of the most popular. Key-value databases or stores represent a simple data model that maps unique keys to a set of one or more values. More specifically, the key-value store stores values and an index to facilitate location of the stored values based on a key. For example, a key can be located that identifies one of a title, author, or publication of a data of a book.

Relational databases are often referred to as SQL databases while some non-relational databases are called noSQL databases or stores. SQL stands for Structured Query Language, which is the primary language utilized to query and otherwise interact with data in a relational database. When SQL is utilized in conjunction with a relational database, the database can be referred to as a SQL-based relational database. However, more often a SQL-based relational database is simply referred to as a SQL database and used as a synonym for a relational database. noSQL is a term utilized to designate databases that differ from SQL-based relational databases. In other words, the term noSQL is used as a synonym for a non-relational database or store such as but not limited to a key-value store.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to facilitating data interaction by mapping between an object model and a key-value data model that supports a notion of worlds. In accordance with aspect of the disclosure, a language-language integrated query (LINQ) infrastructure can be employed to provide such mapping. More particularly, one or more query operators comprising a query can specify interactions with respect to objects. These operators can be mapped to interactions over a key-value data store, results of which can be mapped back to objects. Moreover, the query operators can be specified and executed with respect to one or more key-value worlds, where a world represents a particular context with respect to relationships between values. Further yet, operators can be employed that split a world, merge multiple worlds, as well as enable movement of data across worlds. Still further yet and in accordance with one embodiment, the mapping can be performed with respect to a key-value data model that is the mathematical dual of a relational model (e.g., coSQL).

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates data interaction.

FIG. 2 is a block diagram of one embodiment of a system that facilitates data interaction.

FIG. 3 illustrates two exemplary key-value worlds.

FIG. 4 is a block diagram of exemplary query operators.

FIG. 5 is a graphical illustration of a split and combine operations.

FIG. 6A is a block diagram depicting a marshal operator that is implemented by value.

FIG. 6B is a block diagram illustrating a marshal operator that is implemented by reference.

FIG. 7 depicts an exemplary relational representation.

FIG. 8 illustrates an exemplary relation representation including pointers between tables.

FIG. 9 illustrates an exemplary non-relational key-value representation.

FIG. 10 depicts a generalized key-value representation.

FIG. 11 is a flow chart diagram of a method of mapping between an object model and a key-value data model.

FIG. 12 is a flow chart diagram of a method of facilitating data interaction.

FIG. 13 is a flow chart diagram of an optimization method.

FIG. 14 is a schematic block diagram illustrating a suitable operating environment for aspects of the subject disclosure.

### DETAILED DESCRIPTION

Details below are generally directed toward facilitating data access by mapping between an object model and a key-value data model that supports a notion of worlds. In one embodiment, language-integrated query (LINQ) infrastructure can be exploited to perform such mapping between a computer program and a data store. Accordingly, data can be accessed from a non-relational noSQL or coSQL data model in a similar manner as relational SQL data models. More particularly, query operators can be specified with respect to a particular key-value context referred to as a world herein. Consequently, interactions with respect to key-value data are world based. Further, worlds can be split and/or merged, and data can be moved or otherwise accessed across worlds.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

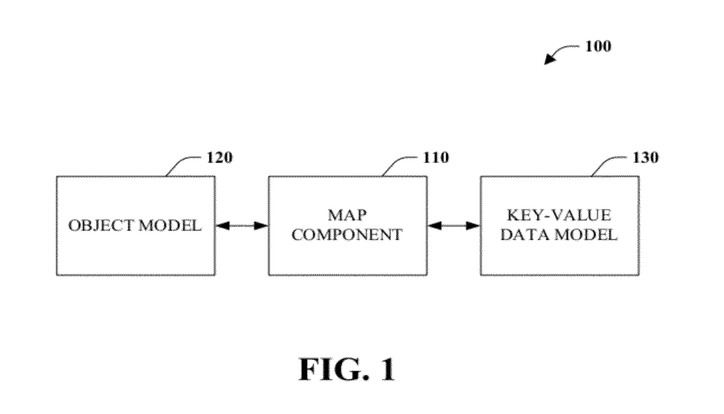

Referring initially to FIG. 1, a system 100 that facilitates data interaction is illustrated, wherein data interaction refers to creating, reading (querying), updating and deleting data. The system 100 includes a map component 110 coupled with an object model 120 and a key-value data model 130 (wherein the object model 120 and key-value data model 130 can be a component as defined herein). The object model 120 refers to objects and properties of objects, among other things, as used with respect to a particular computer-programming language application, for instance to represent and interact with data. A key-value data model 130 specifies how data is stored and accessed. In particular, the key-value data model 130 stores values indexed by unique keys such that given a key, data or a specific value, can be provided in return. Further yet, the key-value data model supports a notion of worlds. The map component 110 is configured to map, or, in other words, provide translations, between the key-value data model 130 and the object model 120. By way of example and not limitation, requests for data with respect to a key-value store can be acquired and mapped, or translated, from an object model representation to a key-value data model. Subsequently, any resulting data can be mapped, or translated, from the key-value data model representation to the object model representation. More specifically, an object class can be specified that represents application data, and interactions with respect to the data, such as queries, can be specified over the object class. The interactions can be translated for local or remote execution over a key-value store and resulting data can be translated back to its respective object representation. In this manner, data access is facilitated by bridging, or providing a conduit, between the models, namely the object model 120 and the key-value data model 130.

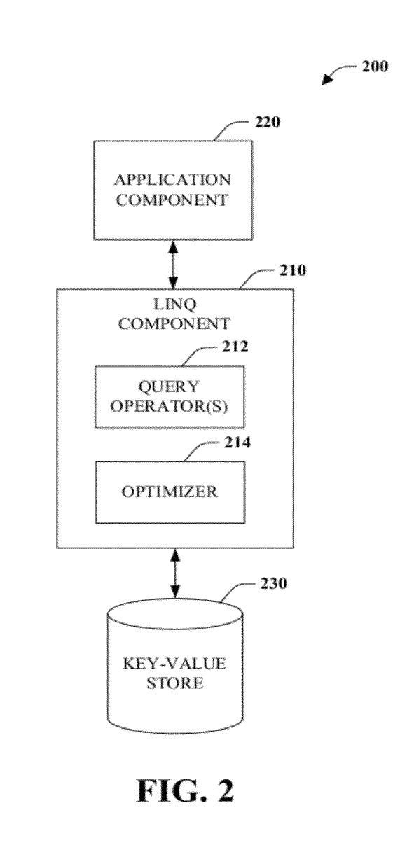

FIG. 2 illustrates one embodiment of a system that facilitates data interaction 200. As shown, a LINQ component 210 can corresponds to an embodiment of the map component 110, an application component 220 is an instance of a particular object model 120, and key-value store 230 is an instance of a key-value data model 130 of FIG. 1. The LINQ component 210, or language-integrated query component, provides functionality related to facilitating data interaction from within programming languages. More specifically, the LINQ component 210 enables a convenient and declarative shorthand query syntax for specification of “query” within a programming language ((e.g., C#®, Visual Basic® . . . ), wherein a query can correspond to a request for data or instruction to manipulate or otherwise interact with data (e.g., update, insert, delete). More specifically, the LINQ component 210 can provide one or more query operators 212 that map to lower-level language constructs or primitives such as methods and lambda expressions. The query operators 212 are provided for various families of operations (e.g., filtering, projection, joining, grouping, ordering . . . ), and can include but are not limited to “where” and “select” operators that map to methods that implement the operators that these names represent. One or more query operators 212 can be specified as part of a query or in other words a query expression. By way of example, a user can specify a query in a form such as “from n in numbers where n<10 select n,” wherein “numbers” is a data source and the query returns integers from the data source that are less than ten. Further, query operators 212 can be combined in various ways to generate queries of arbitrary complexity.

The application component 220 corresponds to a computer program that seeks to interact with the key-value store 230, for example, where the computer program represents and interacts with data utilizing an object model and the key-value store 230 allows interactions by way of a key-value model. More specifically, language integrated queries can be specified within the application component 220 utilizing one or more of the query operators 212, among other things, to express data interaction as a query or in other words a query expression. In one implementation, the query operators 212 can enable SQL-like queries to be expressed over a key-value store. In other words, a familiar query language syntax developed for use with respect to relational databases can be employed with respect to non-relational databases such as the key-value store 230.

The key-value store 230 corresponds to a particular instance of a key-value model wherein data is indexed and accessible by key. The key-value store 230 is one implementation of what is called a noSQL database system that differs from classic relational database systems. In fact, a common interpretation of noSQL is non-relational. In another implementation, the key-value store 230 can be an implementation of a coSQL database system, wherein coSQL refers to the data model that result from dualizing the SQL model or relational model. In other words, coSQL is the mathematical dual of SQL, as will be described further hereinafter. Briefly, the coSQL is a data model that a pure form of a key-value data model such that if you dualize a coSQL data model a SQL data model is returned. This is not true of conventional noSQL data models. Furthermore, the key-value store 230 can comprise one or more worlds.

The query operators 212 can be specified and executed with respect to a world. Herein, “world” refers to a modal logic concept that represents a particular context with respect to relationships between values or collections of values. More formally, a world can represent the transitive closure over values, or, stated differently, a world is a collection of values that is reachable transitively from a root. More concretely, in a key-value store, the value is obtained by looking up an associated key in some context or world. In some sense, a world is analogous to an address space, wherein uniquely identified qualifiers are utilized to make an address unambiguous.

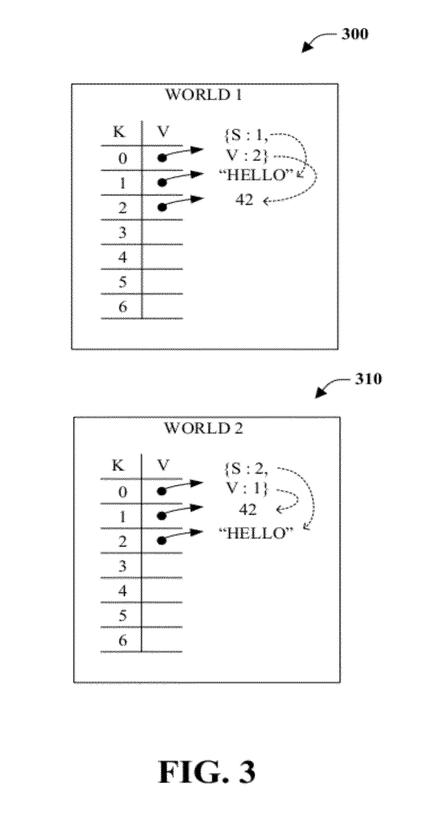

Turning briefly to FIG. 3 two worlds are graphically depicted, namely “World 1” 300 and “World 2” 310. Both worlds include a number of keys and values represented in a tabular form. Furthermore, the referenced values are reachable from a single root (e.g., key 0) as denoted by the dashed arrows. As shown, “World 1” 300 includes three keys “0,” “1,” and “2” that reference respective values “{S: 1, S: 2},” “HELLO,” and “42.” In another form this can be specified as: “(0, [0|→{S: 1, V: 2}, 1|→“HELLO”, 2|→42]).” In order to define operators over such key-value structures, it is helpful to make the concept of world explicit. This is significant in distinguishing which world a value lives in to interpret its keys. As illustrated, “World 2” 310 illustrates the same values in a context including three keys “0,” “1,” and “2” that reference respective values “{S: 2, S: 1},” “42,” and “Hello.” Written differently, the world can be specified as “(0, [0|→{S: 2, V: 1}, 2|→“HELLO”, 1|→42]).” Here, the key-value structures of “World 1” 300 and “World 2” 310 are isomorphic but the values reside in different locations. This is analogous to two processes in an operating system where for each process there is a different object graph.

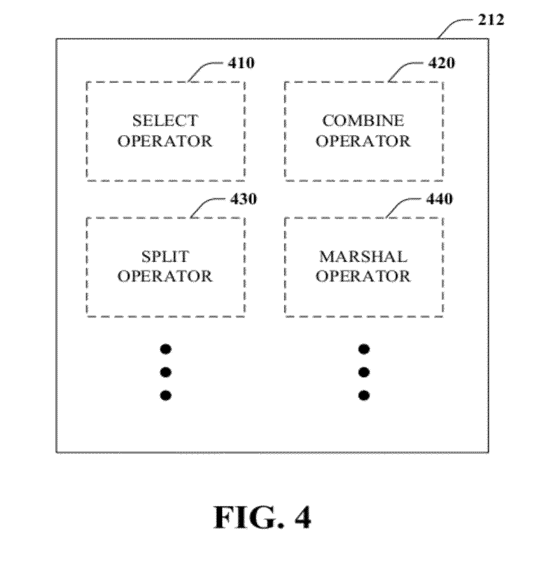

FIG. 4 illustrates exemplary query operators 212 that can be specified and executed to facilitate interaction with respect to a local or remote key-value store. One exemplary operator is the select operator 410 that specifies one or more values to retrieve from a specific key-value world. A formal signature of such an operator can be: “M_{w}<T> Select_{w}<S,T>(M_{w}<S> src, Func<S,T> selector),” where “Select” is performed over a source collection of key-value pairs in a particular world “M_{w}<S> src” with a selector function “Func<S, T> selector” and returns a collection of key-value pairs in the world “w,” “M_{w}<T>.” The select operator 410 can also correspond to a more specific form of select, namely “SelectMany” with a signature such as “M_{w}<T> SelectMany_{w}<S,T>(M_{w}<T> src, Func<S, M_{w}<T>> selector),” that projects each element from a source world “M_{w}<T> src” to a collection and flattens the result into a single collection of key-value pairs in a world “M_{w}<T>.” Along these lines a flatten operator (not explicitly shown) can receive a collection of collections and return a single collection as specified by the following signature: “M_{w}<S> Flatten_{w}<S>(M_{w}<M_{w}<S>> src.”

Various other operators can be directed toward manipulation of worlds including combine operator 420 and split operator 430. The combine operator 420 can take collections of key-value pairs from two worlds and combines them to produce a single world of key-value pairs. Such an operation can remap keys to avoid conflict and can be specified more formally by the following signature: “M_{w+v}<S> Combine_{w,v}<S>(Mᵥ<S> left, Mᵥ <S> right).” By contrast, the split operator 430 can take a collection of key-value pairs in a single world and split them into two different worlds. The split operator 430 can correspond to sharding in a relational context and can have the following signature: “M_{w}<S>x Mᵥ<S> Split_{,w+v}<S>(M_{w+v}<S> src).”Further, a collection “M_{w}<S>” can be partitioned into a maximally dense product of independent collections “M_{w0}<S>, . . . , M_{wn-1}<S>” by repeatedly applying the split operator 430, which can enable sub-collections to be operated on in parallel. Note also that partitions can be independently indexed with respect to the partition or world rather than respecting an enforcing an index of a parent world.

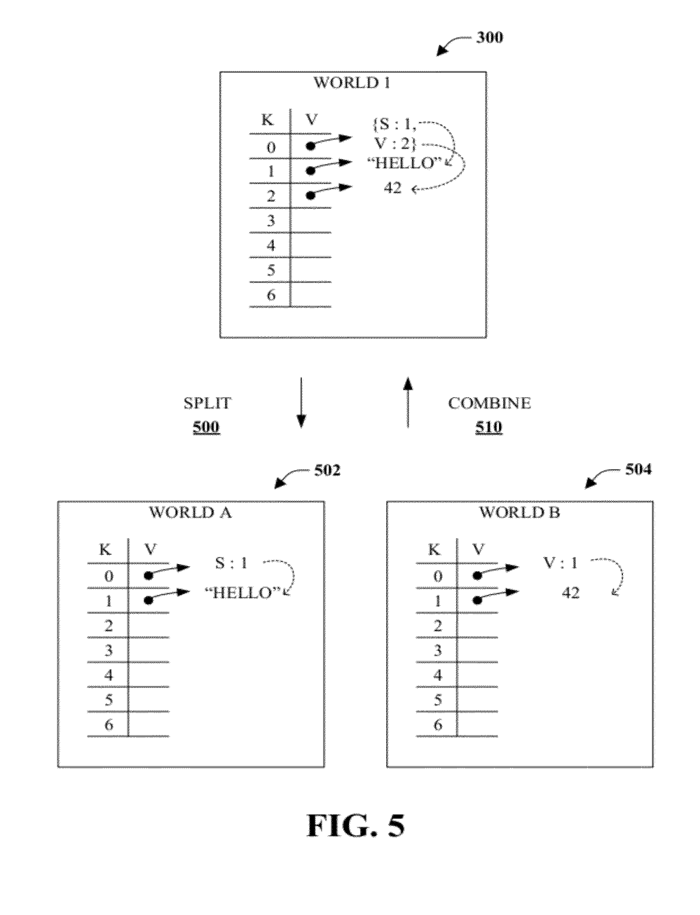

Turning attention briefly to FIG. 5, a split operation 500 and combine operation 510 are graphically depicted. Applying the split operation 500 on a collection in “World 1” 300 returns a collection in “World A” 502 and a collection in “World B” 504. As shown, the “World 1” 300 is partitioned into subsets, or more particularly sub-worlds, where a subset includes a set of values reachable by one root.

In this case, “0|->{S: 2, V: 1}, 2|->“HELLO”, 1|->42” is partitioned into “0|->S: 1, 1|->“HELLO,” and “0|->V: 1, 1|->42.” Note that the subsets are indexed by world. The split operation 500 can be reversed by applying the combine operation 510, which combines “World A” 502 and “World B” 504 into “World 1” 300. During such an operation, the keys can be re-mapped appropriately.

A large number of query operators can be specified and executed with respect to a single world. However, circumstance may exist where values are desired from across multiple worlds. Marshal operator 440 of FIG. 4 can be employed to address these circumstances. A signature for the marshal operator 440 can be “Mᵥ<S> Marshal_{,w+v}<S>(M_{w}<S> src),” wherein a value “S” of a key-value pair in a collection of key-value pairs in world “w” is made available in world “y.” Such functionality can be accomplished in at least two different manners, namely by value or by reference.

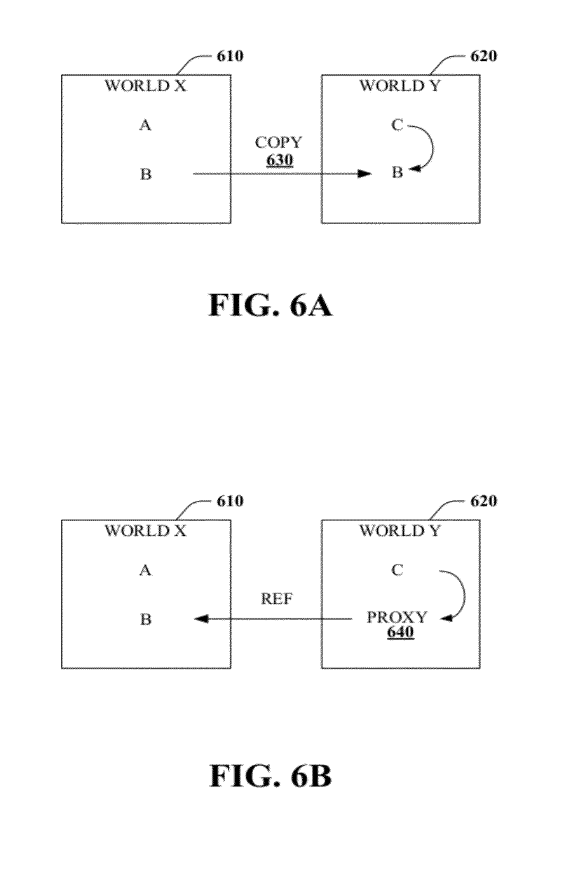

FIG. 6A is a block diagram illustrating one implementation of the marshal operator 440. As shown, there are two worlds: “World X” 610 and “World Y” 620. “World X” 610 includes values “A” and “B,” while “World Y” 620 initially includes solely value “C,” for example where values refer to key-value pairs. If it is desired to interact with value “B” in “World Y” 620, then a copy operation 630 can be executed, which copies the value in “World X” 610 to “World Y” 620. This corresponds to marshaling by value.

FIG. 6B is a block diagram illustrating an alternative implementation of the marshal operator 440. Similar to FIG. 6A, “World X” 610 includes values “A” and “B” and “World Y” 620 initially includes solely value “C,” for instance where value refers to a key-value pair. If one desires to interact with the value “B” in “World Y” 620, a proxy 640 can be employed to reference values across worlds. Here, “C” can reference the proxy 640 that can then reference the value “B” in “World X” 610. More specifically, the proxy 640 can correspond to a value is a key and a world and returns a value from that world. For example, proxy 640 can correspond to the value “(1, World X)”, wherein one is the key of value “B” and the specific world is “World X” 610. Accordingly, an extra layer of indirection is added to facilitate acquisition of a value from a different world. Such an implementation corresponds to marshaling by reference.

Returning to FIG. 2, the LINQ component 210 can also include an optimizer component 214 that optimizes query expressions including one or more query operators 212 specified with respect to a world. In other words, the optimizer component 214 can augment a query expression to optimize or at least improve execution as a function of one or more worlds. By way of example and not limitation, a world can be split into multiple subsets or sub-worlds to facilitate parallel execution with respect to multiple worlds. Similarly, multiple worlds can combined into a single world where values are accessed from the multiple worlds that would otherwise result substantial marshaling that could negatively affect data interaction. Of course, various other optimizations can be employed as a function of world.

One particular use case concerns multitenacy, where a single piece of hardware services multiple clients or tenants rather than employing separate hardware for each client. For example, consider a situation where a database provider has to pay per database and each database has 50 GB of storage available. If the database provider has ten customers that need 5 GB of storage each, the customers can utilize a single database and the provider has to be for a single database. Here, key-value worlds can be utilized to reason about and facilitate segmentation of resources. In particular, data can be stored physically in the same database or store, but logically the data can be in different worlds. Accordingly, in scenarios like the above, cross world data interaction be restricted or confined in some manner to provide privacy and security with respect to the data of different entities.

As previously mentioned and in accordance with one embodiment, aspects of the claimed subject matter can operator over a coSQL data model that is a dual of a conventional SQL data model. The term “dual” and various forms thereof as used herein are intended to refer to mathematical duality as it pertains to category theory. More specifically, duality is a correspondence between properties of a category “C” and dual properties of the opposite category “C^{op}.” Given a statement regarding the category “C,” by interchanging the source and the target of each morphism (mapping) as well as interchanging the order of composing two morphisms, a corresponding dual statement can be obtained regarding the opposite category “C^{op}.” For example, the category “C” can corresponds to a data model and the opposite category “C^{op}” can refer to a dual- or co-data model. “Dualizing” refers to the act of generating a dual from a data model, for example.

The following is high-level discussion regarding deriving the dual a relational data model or the coSQL data model. As will be shown, the result can be a non-relational model or more specifically a key-value data model.

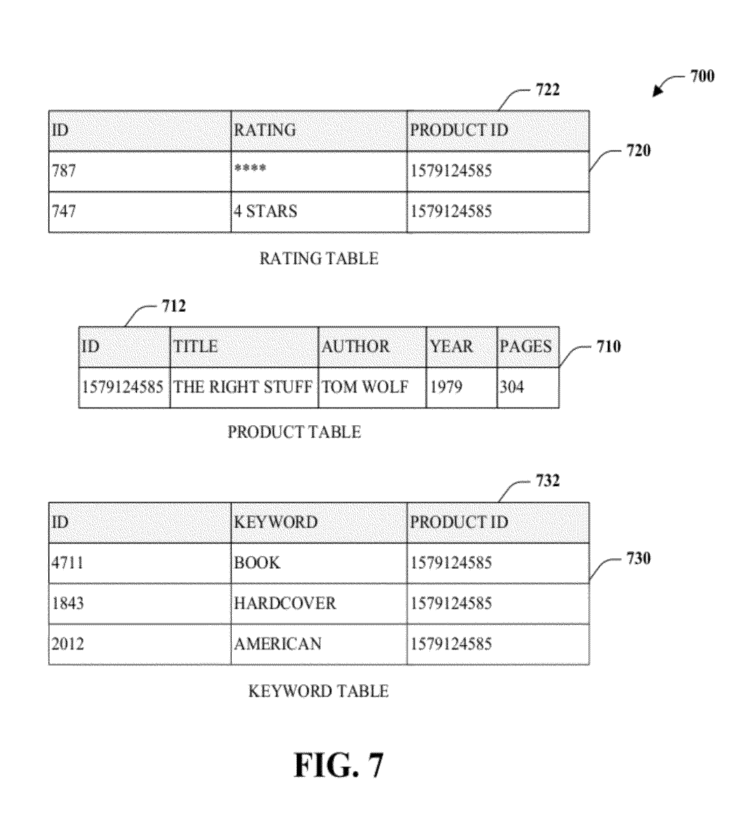

FIG. 7 illustrates an exemplary relational representation 700 for storing product information. As shown, there are three tables linked together by primary and foreign keys. Product table 710 provides primary key “ID” 712 as well as other columns for product information such as title, author, year of publication, and total number of pages. Rating table 720 provides product rating information and a foreign key “PRODUCT ID” 722 referencing the sole record of product table 710. Similarly, keyword table 730 provides keywords associated with a product and includes a foreign key “PRODUCT ID” 732 that refers back to the corresponding record of product table 710.

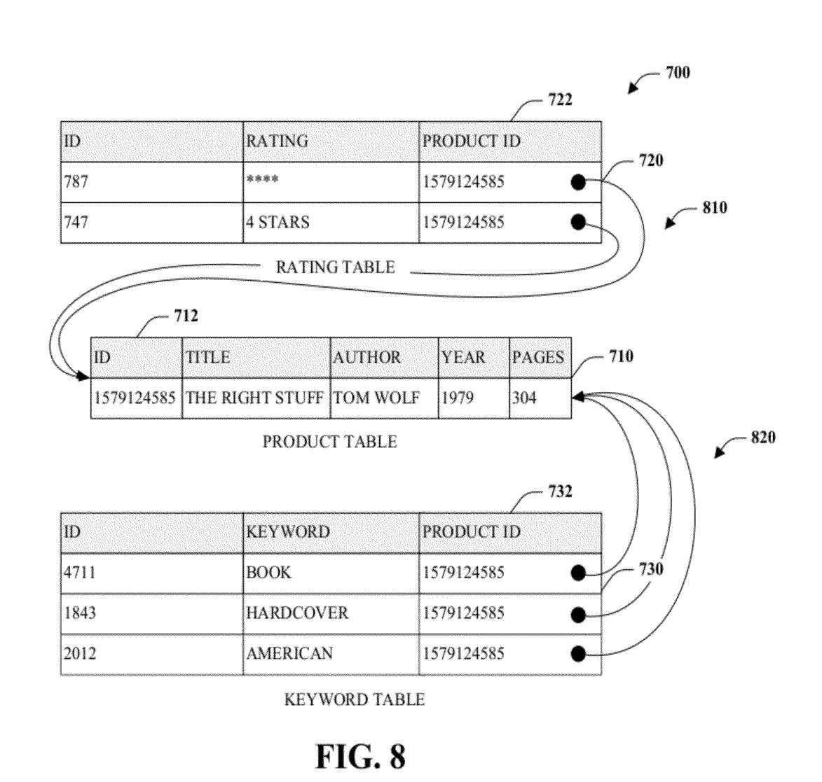

Turning briefly to FIG. 8 the exemplary relational representation 700 of FIG. 7 is illustrated with pointers inserted between foreign keys and primary keys. In particular, pointers 810 point from the foreign key “PRODUCTS ID” 722 of ranking table 720 to the corresponding record identified by the primary key “ID” 712 of the product table 710. Similarly, pointers 820 point from the foreign key “PRODUCTS ID” 732 of the keyword table 730 to the corresponding record identified by the primary key “ID” 712 of the product table 710.

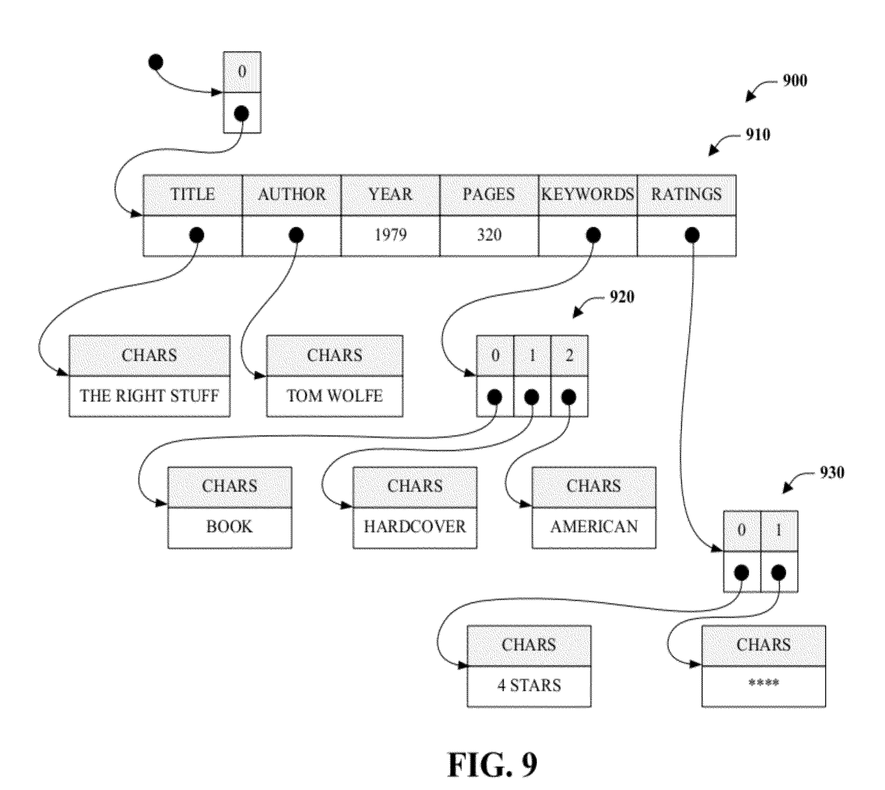

FIG. 9 illustrates an exemplary non-relational key-value representation 900 of the same data provided with respect the exemplary relational representations of FIGS. 7 and 8. Here, rows such as 910, 920, and 930 can store either keys, shown as pointers to values, or scalar values. For instance, row 910 can include keys for title, author, keywords, and ratings and scalar values for year of publication and total number of pages. Row 920 includes three keys that map to three keywords, and row 930 includes two keys that map to two ratings representations.

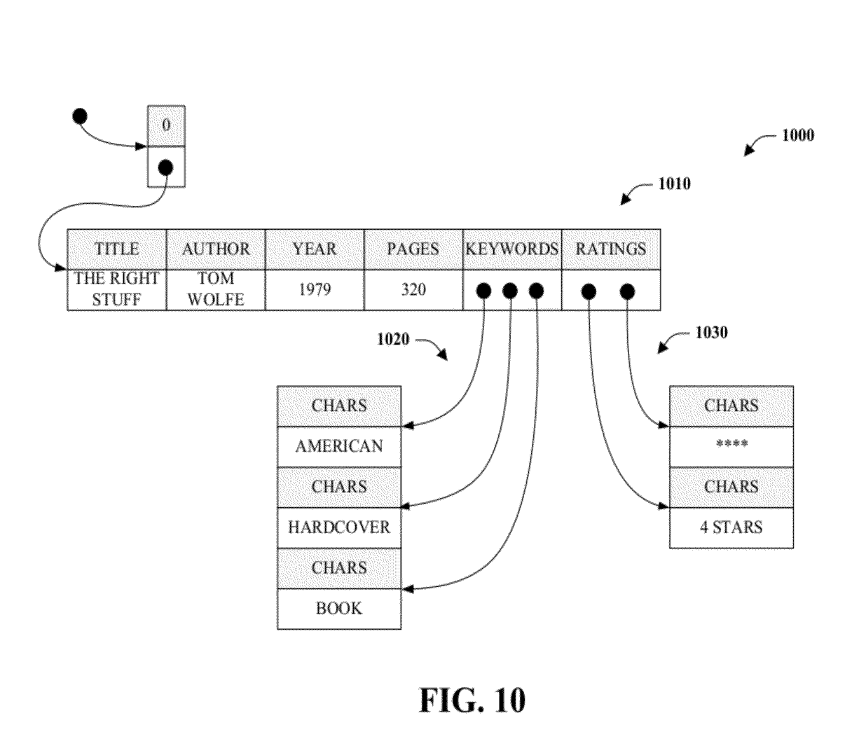

Referring to FIG. 10, an exemplary non-relational key-value representation 1000 is depicted. Here, however, rather than allowing rows to include only scalars and keys, the restriction is relaxed to allow various types of data. Row 1010, corresponding to previous row 910 of FIG. 9, now includes values for title and author and a collection of keys for both keywords and ratings 1020 and 1030, respectively. More specifically, keys 1020 point to keywords and keys 1030 point to rating information.

Compare the exemplary relational representation of FIG. 8 with the exemplary non-relational representation of FIG. 10. Notice that the main distinguishing feature is that the arrows are reversed. More particularly, relational arrows go from a row with a foreign key to a row with a corresponding primary key and non-relational arrows go from a row to a location where data is stored. In other words, in a relational context children point to their parents and in a non-relational context a parents points to their children. What has been shown here is that a non-relational key-value data model is the dual of a relational primary-foreign key data model.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the optimizer component 214 can employ such mechanisms to determine or infer modifications that streamline query expression execution.

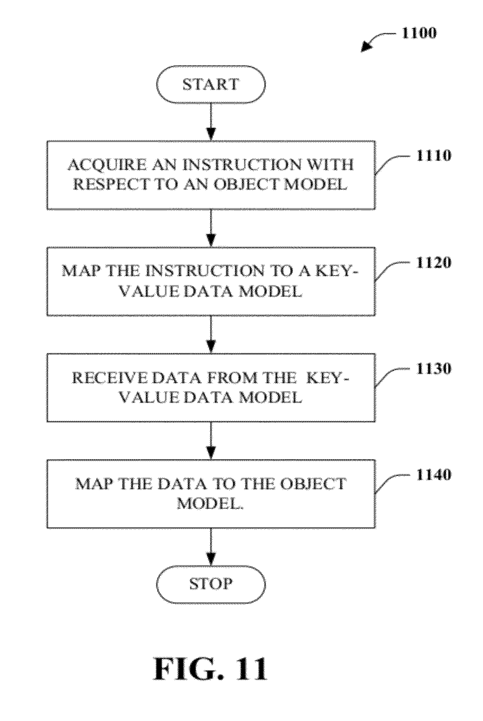

In view of the exemplary systems described supra, methodologies that may be implemented in accordance with the disclosed subject matter will be better appreciated with reference to the flow charts of FIGS. 11-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 11, a method 1100 of mapping between an object model and a key-value data model is illustrated. At reference numeral 1110, an instruction is acquired with respect to an object model. For example, the instruction can relate to creating, reading, updating, or deleting with respect to an object representing application data. At numeral 1120, the instruction is mapped from an operation on the object model to an operation over a local or remote key-value data model. At reference numeral 1130, data can be received from the key-value data model in response to execution of the mapped instruction. For example, where the instruction was a query, or request for data, the resulting data can be received. At numeral 1140, the received data is mapped to back to the object model. In this manner, programmers or other individuals can specify operations with respect to the object model and behind the scenes mapping is done to facilitate interaction with a particular key value store. Moreover, an instruction can specify and the key-value model can support one or more worlds.

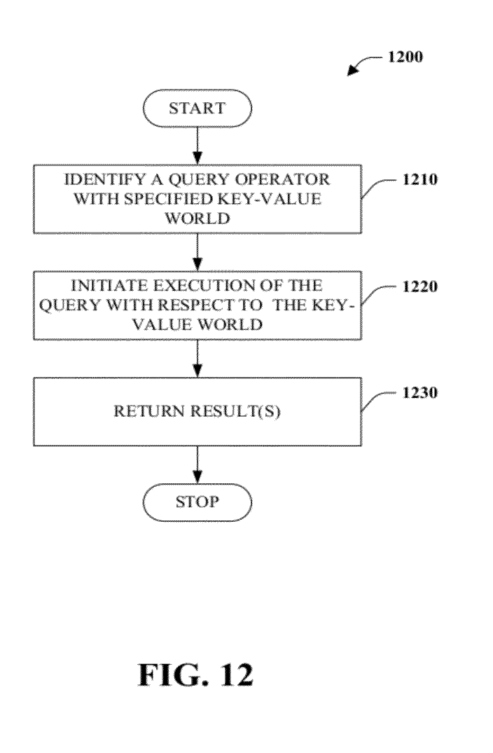

FIG. 12 a method of facilitating data interaction 1200 is illustrated. At reference numeral 1210, a query operator specified with respect to a key-value world is identified, for example as part of a query expression (e.g., programming language integrated query expression). Here, world refers to a modal logic concept that represents a particular context with respect to relationships between values or collections of values. In some sense, a world is analogous to an address space, wherein uniquely identified qualifiers are utilized to make an address unambiguous. At numeral 1220, execution of the query operator is initiated with respect to a key-value world. At reference numeral 1230, any results associated with execution of the query operator can be returned. For example, the results can be mapped back to a program language object model.

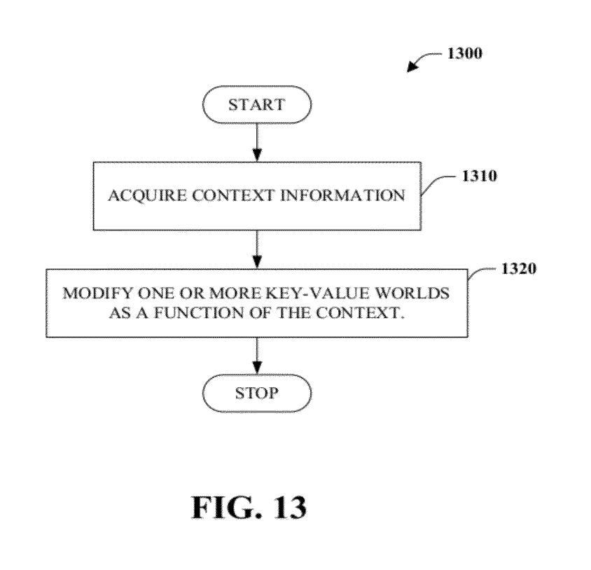

FIG. 13 is a flow chart diagram of a method of optimization 1300. At reference numeral 1320, context information can be received, retrieved or otherwise obtained or acquired from one or more sources related to one or more key-value worlds and interactions with the worlds. At numeral 1320, one or more key-value worlds are modified as a function of the context information. By way of example, context information can indicate that a world exceeds a threshold size, and as such can be divided into two worlds to optimize access to content. In another instance, two worlds can be merged into a single world where context indicates a significant amount of marshalling is occurring between two worlds. Of course, modification can also be initiated as a function of information inferred from other context information including predictions regarding likely usage scenarios, among other things.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

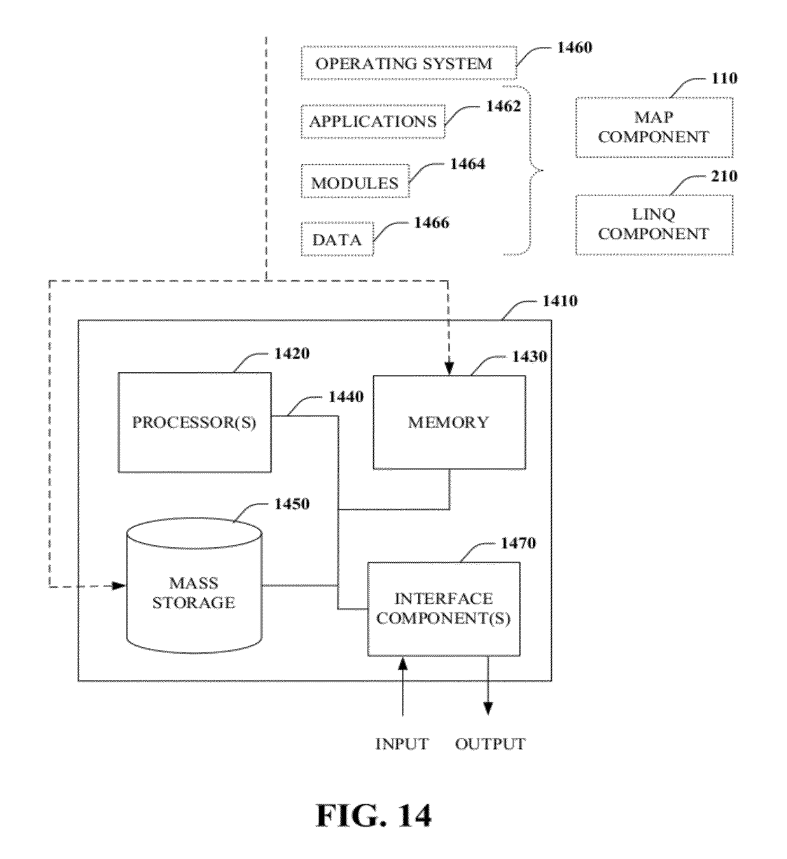

In order to provide a context for the claimed subject matter, FIG. 14 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 14, illustrated is an example general-purpose computer 1410 or computing device (e.g., desktop, laptop, server, hand-held, programmable consumer or industrial electronics, set-top box, game system . . . ). The computer 1410 includes one or more processor(s) 1420, memory 1430, system bus 1440, mass storage 1450, and one or more interface components 1470. The system bus 1440 communicatively couples at least the above system components. However, it is to be appreciated that in its simplest form the computer 1410 can include one or more processors 1420 coupled to memory 1430 that execute various computer executable actions, instructions, and or components stored in memory 1430.

The processor(s) 1420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1420 may also be implemented as a combination of computing devices, for example a combination of a DSP and a microprocessor, a plurality of microprocessors, multi-core processors, one or more microprocessors in conjunction with a DSP core, or any other such configuration.

The computer 1410 can include or otherwise interact with a variety of computer-readable media to facilitate control of the computer 1410 to implement one or more aspects of the claimed subject matter. The computer-readable media can be any available media that can be accessed by the computer 1410 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1410.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1430 and mass storage 1450 are examples of computer-readable storage media. Depending on the exact configuration and type of computing device, memory 1430 may be volatile (e.g., RAM), non-volatile (e.g., ROM, flash memory . . . ) or some combination of the two. By way of example, the basic input/output system (BIOS), including basic routines to transfer information between elements within the computer 1410, such as during start-up, can be stored in nonvolatile memory, while volatile memory can act as external cache memory to facilitate processing by the processor(s) 1420, among other things.

Mass storage 1450 includes removable/non-removable, volatile/non-volatile computer storage media for storage of large amounts of data relative to the memory 1430. For example, mass storage 1450 includes, but is not limited to, one or more devices such as a magnetic or optical disk drive, floppy disk drive, flash memory, solid-state drive, or memory stick.

Memory 1430 and mass storage 1450 can include, or have stored therein, operating system 1460, one or more applications 1462, one or more program modules 1464, and data 1466. The operating system 1460 acts to control and allocate resources of the computer 1410. Applications 1462 include one or both of system and application software and can exploit management of resources by the operating system 1460 through program modules 1464 and data 1466 stored in memory 1430 and/or mass storage 1450 to perform one or more actions. Accordingly, applications 1462 can turn a general-purpose computer 1410 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the map component 110 and the LINQ component 210 can be, or form part, of an application 1462, and include one or more modules 1464 and data 1466 stored in memory and/or mass storage 1450 whose functionality can be realized when executed by one or more processor(s) 1420.

In accordance with one particular embodiment, the processor(s) 1420 can correspond to a system on a chip (SOC) or like architecture including, or in other words integrating, both hardware and software on a single integrated circuit substrate. Here, the processor(s) 1420 can include one or more processors as well as memory at least similar to processor(s) 1420 and memory 1430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the map component 110, the LINQ component 210, and/or associated functionality can be embedded within hardware in a SOC architecture.

The computer 1410 also includes one or more interface components 1470 that are communicatively coupled to the system bus 1440 and facilitate interaction with the computer 1410. By way of example, the interface component 1470 can be a port (e.g., serial, parallel, PCMCIA, USB, FireWire . . . ) or an interface card (e.g., sound, video . . . ) or the like. In one example implementation, the interface component 1470 can be embodied as a user input/output interface to enable a user to enter commands and information into the computer 1410 through one or more input devices (e.g., pointing device such as a mouse, trackball, stylus, touch pad, keyboard, microphone, joystick, game pad, satellite dish, scanner, camera, other computer . . . ). In another example implementation, the interface component 1470 can be embodied as an output peripheral interface to supply output to displays (e.g., CRT, LCD, plasma . . . ), speakers, printers, and/or other computers, among other things. Still further yet, the interface component 1470 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating data interaction, comprising:
employing at least one processor configured to execute computer-executable instructions stored in memory to perform the following acts:
mapping data between an object model and a key-value data model that supports a notion of one or more worlds.

2. The method of claim 1 further comprises mapping at least one query operator specified with respect to the object model to the key-value data model, wherein the query operator at least one of creates, reads, updates, or deletes data with respect to the key-value data model and a world.

3. The method of claim 2 further comprises mapping the at least one query operator specified with respect to at least one key-value world.

4. The method of claim 3 further comprises mapping a query operator that specifies partitioning of the at least one key-value world into independent sub-worlds.

5. The method of claim 3 further comprises mapping a query operator that specifies merging of multiple key-value pair worlds into a single key-value pair world.

6. The method of claim 3 further comprises mapping a query operator that specifies moving key-value pairs between worlds by value.

7. The method of claim 3 further comprises mapping a query operator that specifies moving key-value pairs between worlds by reference with a proxy.

8. The method of claim 2 further comprises optimizing a query expression including one or more query operators as a function of one or more worlds specified by the one or more query operators.

9. A system that facilitates data interaction, comprising:
a processor coupled to a memory, the processor configured to execute the following computer-executable components stored in the memory:
a first component configured to map a key-value data model to an object model, wherein the object model is expressed in a programming language that enables specification of a language-integrated query over a key-value data store that spans one or more worlds.

10. The system of claim 9, the language-integrated query includes a query operator that expresses functionality related to a key-value world.

11. The system of claim 10, a value is indexed by a key based on the key-value world.

12. The system of claim 10, the query operator is configured to partition the key-value world into mutually independent world subsets.

13. The system of claim 10, the query operator is configured to merge multiple independent key-value worlds into a single key-value world.

14. The system of claim 10, the query operator is configured to move values across key-value worlds.

15. The system of claim 10, the query operator is configured to employ a proxy to enable cross-world data interaction.

16. The system of claim 10, the key-value world is stored with other key-value worlds on a single physical store separated logically.

17. The system of claim 9, the key-value data model is a mathematical dual of a relational data model.

18. A computer-readable storage medium having instructions stored thereon that enables at least one processor to perform the following acts:
mapping a key-value data model to an object model, the object model is expressed in a programming language that includes a language-integrated query specified over a key-value data store comprising one or more worlds.

19. The computer-readable storage medium of claim 18 further comprises initiating execution of a query operator specified as part of the language-integrated query with respect to a key-value world.

20. The computer-readable storage medium of claim 19 further comprises initiating execution of a query operator configured to split the key-value world or merge two or more key-value worlds.
